(19) United States
(12) Patent Application Publication
(10) Pub. No.: US 2024/0135178 A1
(43) Pub. Date: Apr. 25, 2024

(54) FORWARD SIGNAL PROPAGATION LEARNING

(71) Applicant: University of Massachusetts, Boston, MA (US)

(72) Inventors: Adam Kohan, Amherst, MA (US); Edward Rietman, Grantham, NH (US); Hava Siegelmann, Amherst, MA (US)

(21) Appl. No.: 18/486,628

(22) Filed: Oct. 13, 2023

Related U.S. Application Data
(60) Provisional application No. 63/415,840, filed on Oct. 13, 2022.

(51) Int. Cl. G06N 3/08; G06N 3/0499; G06N 3/063

(52) U.S. Cl. CPC G06N 3/08; G06N 3/0499; G06N 3/063

(57) ABSTRACT

Examples described herein provide a computer-implemented method for training a neural network using forward signal propagation learning. The method includes receiving, at a first layer of the neural network, an input value and a label associated with the input value. The method further includes calculating, for the first layer of the neural network, a first loss value based at least in part on outputs of the first layer for the input value and for the label. The method further includes updating, based at least in part on the first loss value, the first layer of the neural network based at least in part on the outputs of the first layer for the input value and for the label.

### CROSS-REFERENCE TO RELATED APPLICATIONS

This application claims the benefit of U.S. Provisional Application No. 63/415,840 filed Oct. 13, 2022, the disclosure of which is incorporated herein by reference in its entirety.

### BACKGROUND

Embodiments described herein generally relate to machine learning, and more specifically, to forward signal propagation learning.

Machine learning involves creating a model by training a machine learning algorithm using training data. The training data enables the machine learning algorithm to learn, and a trained model is created as a result. Some machine learning models use neural networks, which are algorithms that attempt to operate as human brains do using neurons that activate when certain conditions are met. Training neural networks involves adjusting neural network parameters (e.g., weights, biases) that define when neurons activate. One technique for training neural networks (particularly feedforward neural networks) is “backpropagation.”

### SUMMARY

In one exemplary embodiment, a method for training a neural network using forward signal propagation learning is provided. The method includes receiving, at a first layer of the neural network, an input value and a label associated with the input value. The method further includes calculating, for the first layer of the neural network, a first loss value based at least in part on outputs of the first layer for the input value and for the label. The method further includes updating, based at least in part on the first loss value, the first layer of the neural network based at least in part on the outputs of the first layer for the input value and for the label.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of components of a machine learning training and inference system according to one or more embodiments described herein;

FIGS. 2A-2H together depict a comparison of learning algorithms with relaxing learning constraints under backpropagation, where FIG. 2H depicts an example of forward signal propagation learning according to one or more embodiments described herein;

FIG. 3 depicts a table according to one or more embodiments described herein;

FIG. 4A depicts an example of forward signal propagation learning according to one or more embodiments described herein;

FIG. 4B depicts an example of forward signal propagation learning according to one or more embodiments described herein;

FIG. 4C depicts an example of forward signal propagation learning according to one or more embodiments described herein;

FIG. 5 depicts a flow diagram of a method for forward signal propagation learning according to one or more embodiments described herein;

FIGS. 6A-6D depict tables according to one or more embodiments described herein;

FIG. 7 depicts three graphs for forward signal propagation learning updating weights according to one or more embodiments described herein;

FIG. 8 depicts a table according to one or more embodiments described herein; and

FIG. 9 depicts a block diagram of a processing system for implementing one or more embodiments described herein.

The diagrams depicted herein are illustrative. There can be many variations to the diagram or the operations described therein without departing from the scope of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

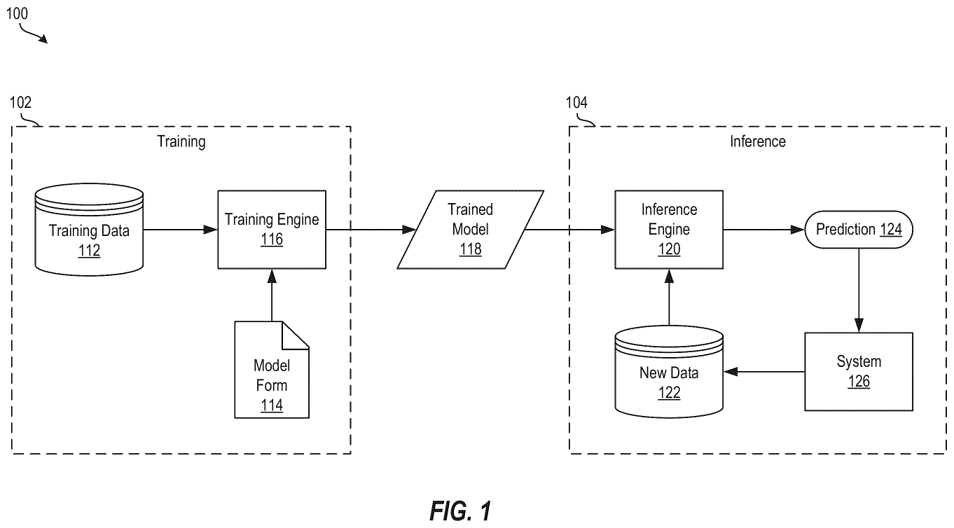

One or more embodiments described herein provides forward signal propagation learning. Turning now to FIG. 1, a block diagram of components of a machine learning training and inference system 100 are provided according to one or more embodiments described herein.

One or more embodiments described herein can utilize machine learning techniques to perform tasks, such as natural language processing, object recognition in images, and/or the like, including combinations and/or multiples thereof. More specifically, one or more embodiments described herein can incorporate and utilize rule-based decision making and artificial intelligence (AI) reasoning to accomplish the various operations. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for natural language processing, object recognition in images, and/or the like, including combinations and/or multiples thereof, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP).

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

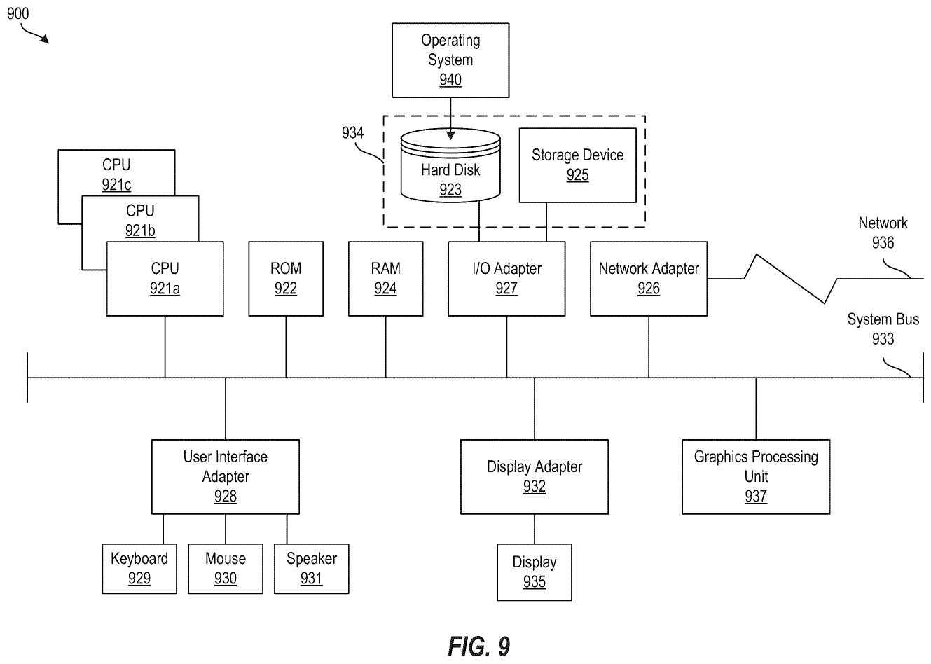

Systems for training and using a machine learning model are now described in more detail with reference to FIG. 1. The system 100 performs training 102 and inference 104. During training 102, a training engine 116 trains a model (e.g., the trained model 118) to perform a task, such as natural language processing, object recognition in images, and/or the like, including combinations and/or multiples thereof. Inference 104 is the process of implementing the trained model 118 to perform the desired/trained task in the context of a larger system (e.g., a system 126). All or a portion of the system 100 shown in FIG. 1 can be implemented, for example by all or a subset of the processing system 900 of FIG. 9.

The training 102 begins with training data 112, which may be structured or unstructured data. According to one or more embodiments described herein, the training data 112 includes images. The training engine 116 receives the training data 112 and a model form 114. The model form 114 represents a base model that is untrained. The model form 114 can have preset weights and biases, which can be adjusted during training. It should be appreciated that the model form 114 can be selected from many different model forms depending on the task to be performed. For example, where the training 102 is to train a model to perform image classification, the model form 114 may be a model form of a CNN. The training 102 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 112 includes labeled images, including images of the object of interest with associated labels (ground truth) and other images that do not include the object of interest with associated labels. In this example, the training engine 116 takes as input a training image from the training data 112, makes a prediction for classifying the image, and compares the prediction to the known label. The training engine 116 then adjusts weights and/or biases of the model based on results of the comparison, such as by using backpropagation. The training 102 may be performed multiple times (referred to as “epochs”) until a suitable model is trained (e.g., the trained model 118).

Once trained, the trained model 118 can be used to perform inference 104 to perform a task based on the training (e.g., to perform a task that the model was trained to perform). The inference engine 120 applies the trained model 118 to new data 122 (e.g., real-world, non-training data). For example, if the trained model 118 is trained to classify images of a particular object, such as a chair, the new data 122 can be an image of a chair that was not part of the training data 112. In this way, the new data 122 represents data to which the model 118 has not been exposed. The inference engine 120 makes a prediction 124 (e.g., a classification of an object in an image of the new data 122) and passes the prediction 124 to the system 126 (e.g., the 900 of FIG. 9). The system 126 can, based on the prediction 124, taken an action, perform an operation, perform an analysis, and/or the like, including combinations and/or multiples thereof. In some embodiments, the system 126 can add to and/or modify the new data 122 based on the prediction 124.

In accordance with one or more embodiments, the predictions 124 generated by the inference engine 120 are periodically monitored and verified to ensure that the inference engine 120 is operating as expected. Based on the verification, additional training 102 may occur using the trained model 118 as the starting point. The additional training 102 may include all or a subset of the original training data 112 and/or new training data 112. In accordance with one or more embodiments, the training 102 includes updating the trained model 118 to account for changes in expected input data.

One or more embodiments provides a new learning algorithm for propagating a learning signal and updating neural network parameters via a forward pass, as an alternative to backpropagation. According to an embodiment of forward signal propagation learning (also referred to as “FSP” and/or “sigprop”), the forward path is used for learning and inference instead of a backward path, so there are no additional structural or computational constraints on learning, such as feedback connectivity, weight transport, or a backward pass, which exist under backpropagation. Forward signal propagation enables global supervised learning using a forward path and is applicable to any layer, network, graph, or system where there are changing parameters (e.g., an adaptive system). It should be appreciated that other types of neural networks are also possible, such as the following: graph neural network, spiking neural network, temporal neural network, echo state network, sparse neural network, dense neural network, feed-forward, convolutional, transformer, residual networks, recurrent, and/or the like, including combinations and/or multiples thereof. Forward signal propagation can be implemented as a designing hardware for adaptive technology and brings learning to hardware, thus creating adaptive systems. This is ideal for parallel training (also referred to as “parallel pipeline”) of layers or modules. In biology, this explains how neurons without feedback connections can still receive a global learning signal. In computer hardware, this provides an approach for global supervised learning without backward connectivity. Forward signal propagation by design has better compatibility with models of learning in the brain and in hardware than backpropagation and alternative approaches to relaxing learning constraints. Further, forward signal propagation is more efficient in time and memory than conventional approaches to learning, such as backpropagation. For example, forward signal processing can be implemented in low or constrained resource systems and edge devices. Forward signal propagation provides useful learning signals in context to backpropagation. As one example, to further support relevance to biological and hardware learning, forward signal propagation can be used to train continuous time neural networks with Hebbian updates and train spiking neural networks without surrogate functions. FIG. 1 is only one example system for using forward signal propagation learning according to one or more embodiments described herein. Other systems are also possible, and forward signal propagation learning can be used with any suitable structures in or design of adaptive systems. For example, forward signal propagation learning can be implemented in any hardware, like neuromorphic chips, graphics processing units, tensor processing units, application specific integrated circuits, field programmable gate arrays, and/or the like, including combinations and/or multiples thereof.

Forward signal propagation learning can be implemented on rate-based, spike-based, time-based, phase-based, and/or any other type of network. Forward signal propagation can be implemented on simulations or emulators of hardware or software systems. Forward signal propagation learning can be implemented using any type of learning, such as supervised learning, unsupervised learning, reinforcement learning, semi-supervised learning, and/or the like, including combinations and/or multiples thereof. According to one or more embodiments described herein, forward signal propagation learning can be applied for any paradigm where learning or adaptive changes in a system is involved, like deep learning, neural networks, models of the brain, and/or the like, including combinations and/or multiples thereof. According to one or more embodiments described herein, forward signal propagation learning can be implemented on individual or multiple additive systems, working together or separately, like individual adaptive systems, copies of the same adaptive system, pieces of an adaptive system, combination of additive systems, and/or the like, including combinations and/or multiples thereof. Forward signal propagation learning can be implemented for any learning or inference technique, such as parallel training, inference in parts, training multiple systems together, and/or the like, including combinations and/or multiples thereof. Forward signal propagation learning can be implemented in a cloud computing environment or any joint system where adaption is implemented. Forward signal propagation learning can be implemented for lifelong learning or any technique where training continues throughout the lifetime of an additive system. Forward signal propagation learning can be used alone or with any technique that improves adaptive systems, such as dropout, batch normalization, regularization, data augmentation, augmentation of the adaptive system, and/or the like, including combinations and/or multiples thereof.

The success of deep learning is attributed to the backpropagation of errors algorithm for training artificial neural networks. However, the constraints necessary for backpropagation to take place are incompatible with learning in the brain and in computer hardware, are computationally inefficient for memory and time, and bottleneck parallel learning. These learning constraints under backpropagation come from calculating the contribution of each neuron to the network's output error. This calculation during training occurs in two phases. First, the input is fed completely through the network storing the activations of neurons for the next phase and producing an output; this phase is known as the forward pass. Second, the error between the input's target and network's output is fed in reverse order of the forward pass through the network to produce parameter updates using the stored neuron activations; this phase is known as the backward pass. According to one or more embodiments described herein, any suitable type of input and associated context (e.g., label) can be used, such as images, text, audio, numbers, graphs, tables, classes, and/or the like, including combinations and/or multiples thereof.

These two phases of conventional backpropagation learning have the following learning constraints. The forward pass stores the activation of every neuron for the backward pass, increasing memory overhead. The forward and backward passes need to complete before receiving the next inputs, pausing resources. Network learning parameters are then updated after and in reverse order of the forward pass, which is sequential and synchronous.

The backward pass uses its own feedback connectivity to the neurons, increasing structural complexity. The feedback connectivity relies on weight symmetry with forward connectivity, known as the weight transport problem. The backward pass uses a different type of computation than the forward pass, adding computational complexity. In total, these constraints prohibit parallelization of computations during learning; increase memory usage, run time, and the number of computations; and bound the network structure.

These learning constraints of conventional backpropagation are difficult to reconcile with learning in the brain. Particularly, the backward pass is considered to be problematic as (1) the brain does not have the comprehensive feedback connectivity necessary for every neuron; (2) neither is neural feedback known to be a distinct type of computation, separate from feedforward activity; and (3) the feedback and feedforward connectivity would need to have weight symmetry.

These learning constraints of conventional backpropagation also hinder efficient implementations of backpropagation and error based learning algorithms on hardware. For example, weight symmetry is incompatible with elementary computing units which are not bidirectional. Further, the transportation of non local weight and error information uses special communication channels in hardware. Also, spiking equations are non-derivable, non-continuous. Hardware implementations of learning algorithms may provide insight into learning in the brain. An efficient, empirically competitive algorithm to backpropagation on hardware will likely parallel learning in the brain.

These constraints of conventional backpropagation can be categorized as follows. First, backwardpass unlocking would allow for the parameters to be updated in parallel after the forward pass has completed. Second, forwardpass unlocking would allow for individual parameters to be asynchronously updated once the forward pass has reached them without waiting for the forward pass to complete. These categories directly reference parallel computation, but also have implications on network structure, memory, and run-time. For example, backwardpass locking implies top-down feedback connectivity. Although alternative approaches to relax learning constraints have been proposed, such approaches fail to solve these constraints on conventional backpropagation.

One or more embodiments described herein provide for a forward signal propagation learning (referred to as “FSP” and/or “sigprop”), a new learning algorithm for propagating a learning signal and updating neural network parameters via a forward pass. FSP addresses the above learning constraints associated with conventional backpropagation and is completely forwardpass unlocked. At its core, forward signal propagation generates targets from learning signals and then re-uses the forward path to propagate those targets to hidden layers and update parameters. FSP has the following desirable features. First, inputs and learning signals use the same forward path, so there are no additional structural or computational requirements for learning, such as feedback connectivity, weight transport, and/or a backward pass. Second, without a backward pass, the network parameters are updated as soon as they are reached by a forward pass containing the learning signal. FSP does not block the next input or store activations, so FSP is ideal for parallel training of layers or modules. Third, since the same forwardpass used for inputs is used for updating parameters, a single type of computation. Forward signal propagation learning addresses and overcomes these constraints, and does so with a global learning signal, of conventional backpropagation.

According to one or more embodiments described herein, learning signals can be fed through the forward path to train neurons. Feedback connectivity is not necessary for learning. In biology, this means that neurons that do not have feedback connections can still receive a global learning signal. In computer hardware, this means that global learning (e.g., supervised learning, reinforcement learning, and/or the like, including combinations and/or multiples thereof) is possible even though there is no backward connectivity.

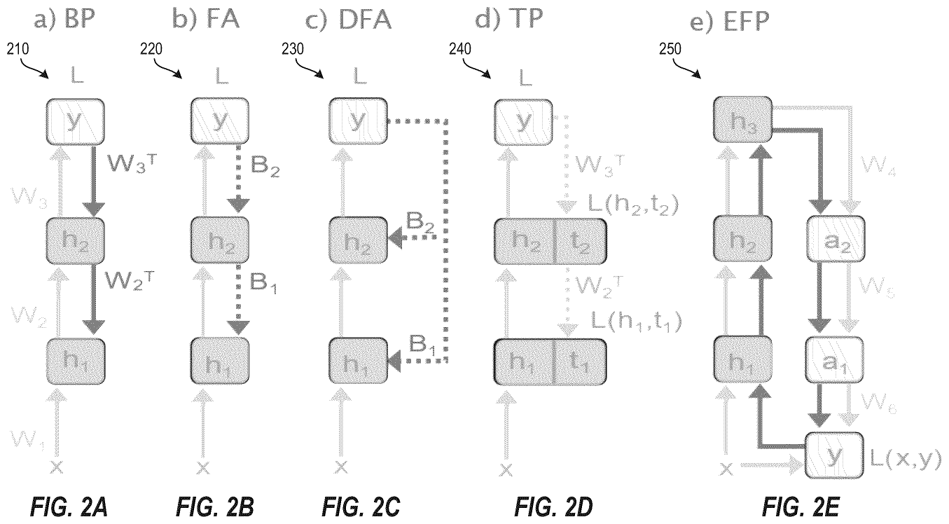

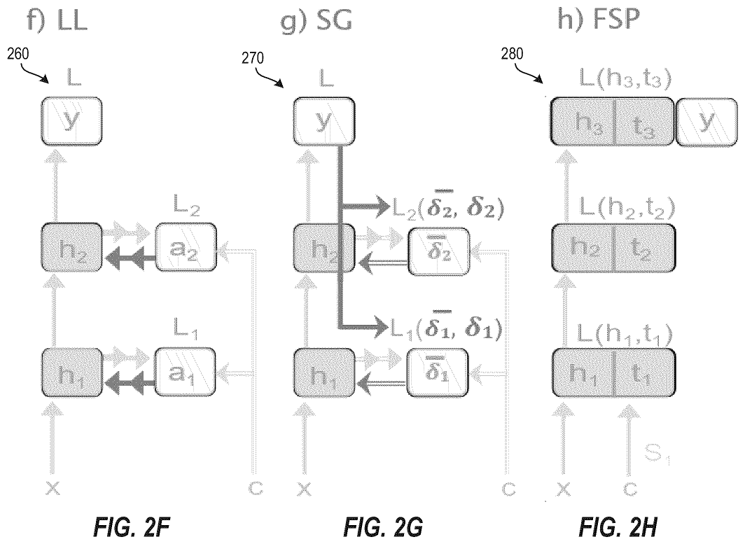

Forward signal propagation learning improves on relaxing learning constraints over alternative approaches. FIGS. 2A-2H together depict a comparison of learning algorithms with relaxing learning constraints under backpropagation according to one or more embodiments described herein.

FIG. 2A depicts a network 210 for the backpropagation algorithm. FIGS. 2B and 2C depict networks 220, 230 for the feedback alignment (FA) algorithm and the direct feedback alignment (DFA) respectively. Feedback alignment based algorithms do not solve forwardpass locking and require additional connectivity. FIG. 2D depicts a network 240 for target propagation (TP), which uses a single type of computation for training and inference but is forwardpass locked and requires feedback connectivity. FIG. 2E depicts a network 250 for error forward propagation (EFP) for closed loop systems or autoencoders that reuses the forward connectivity to propagate error but is otherwise similarly constrained as backpropagation. FIG. 2F depicts a network 260 for local learning (LL) with layer-wise training using auxiliary classifiers. Local learning is update and backward locked at the layer level due to the auxiliary networks. FIG. 2G depicts a network 270 for the synthetic gradients (SG) algorithm. Synthetic gradients-based algorithms are update and backwardpass unlocked after learning to predict the synthetic gradient.

In contrast to the networks 210-270 of FIGS. 2A-2G respectively, FIG. 2H depicts a network 280 for the forward signal propagation learning algorithm according to one or more embodiments described herein. The forward signal propagation feeds the learning signal forward through the network to solve the weight transport and forwardpass locking problems without requiring additional connectivity. For FSP, taking t₃ with h₃ produces y; however, a classification layer may also be used.

In FIG. 2B, feedback alignment uses fixed random weights to transport error gradient information back to hidden layers, instead of using symmetric weights. The sign concordance between the forward and feedback weights is enough to deliver effective error signals. During learning, the forward weights move to align with the random feedback weights and have approximate symmetry, forming an angle below substantially 90°. Feedback alignment addresses the weight transport problem but remains update and backward locked.

In FIG. 2C, direct feedback alignment propagates the error directly to each hidden layer and is additionally backwardpass unlocked. One or more embodiment described herein improve DFA where the forwardpass unlocked. DFA performs similarly to backpropagation on the Canadian Institute for Advanced Research CIFAR-10 dataset for small fully-connected networks with dropout but performs more poorly for convolutional neural networks for example. Forward signal propagation performs better than DFA and FA for convolutional neural networks.

Feedback alignment-based algorithms also rely on systematic feedback connections to layers and neurons. Though it is possible, there is no evidence in the neocortex of the comprehensive level of connectivity necessary for every neuron to receive feedback (reciprocal connectivity). The forward signal propagation according to embodiments described herein is capable of explaining how neurons without feedback connections learn. That is, neurons without feedback connectivity receive feedback through their feedforward connectivity.

An alternative approach that minimizes feedback connectivity is local learning algorithms as shown in FIG. 2F. In local learning algorithms, layers are trained independently by calculating a separate loss for each layer using an auxiliary classifier per layer. Local learning algorithms have achieved performance close to backpropagation on the CIFAR-10 dataset and are making progress on the ImageNet dataset. Local learning trains each layer and auxiliary classifier using backpropagation. At the layer level, local learning has the weight transport problem and is update and backward locked. In such cases, feedback alignment can be used to backwardpass unlock the layers. Feedback learning does not use a global learning signal but learns greedily. In another approach, synthetic gradients are used to train layers independently. A synthetic gradient algorithm trains auxiliary networks to predict the gradient of the backward pass from the input, the synthetic gradient, as shown in FIG. 2G. Similar to local learning, synthetic gradient approaches train the auxiliary networks using backpropagation. Until the auxiliary networks are trained, synthetic gradient has the weight transport problem and is update and backward locked at the network level. In contrast, one or more embodiments described herein that use a signal propagation learning algorithm is forwardpass unlocked, combines a global learning signal with local learning, and is compatible with learning in hardware where there is no backward connectivity.

Forwardpass unlocked algorithms do not necessarily address the limitations in biological and hardware learning models with having different types of computations for inference and learning. In forward signal propagation learning, the approach to having a single type of computation for inference and learning is similar to (but different from) target propagation. Target propagation generates a target activation for each layer instead of gradients by propagating backward through the network as shown in FIG. 2D. Target propagation uses reciprocal connectivity and is update and backward locked. In contrast, forward signal propagation learning generates a target activation at each layer by going forward through the network. An alternative approach, equilibrium propagation (EP) is an energy based model using a local contrastive Hebbian learning which uses the same computation in the inference and learning phases. The model is a continuous recurrent neural network that minimizes the difference between two fixed points: when receiving an input only and when receiving the target for error correction. Symmetric and random feedback weights work in these models; however, these models still use comprehensive connectivity for each layer and are forwardpass locked. In contrast, forward signal propagation learning works in the equilibrium propagation model, a continuous recurrent neural model that more closely models neural networks in the brain.

Another approach that reuses the forward connectivity for learning is error forward propagation (EFP) as shown in FIG. 2D. Error forward propagation is for closed loop control systems or autoencoders. In either case, the output of the network is in the same space as the input of the network. These works calculate an error between the output and input of the network and then propagate the error forward through the network, instead of backward as in error backpropagation. Error forward propagation is backwardpass locked and forward-pass locked and uses different types of computation for learning and inference. In contrast, forward signal propagation learning uses a single type of computation and is backwardpass unlocked and forwardpass unlocked.

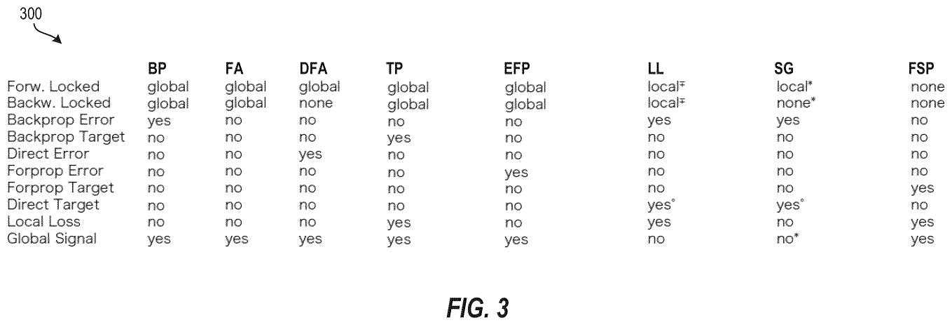

FIG. 3 depicts a table 300 according to one or more embodiments described herein. The table 300 shows characteristics of each of the networks 210-280 of FIGS. 2A-2H respectively. The table 300 includes the following characteristics but is not so limited: forwardpass locked (global, local, or none), backwardpass locked (global, local, or none), backpropagation error (yes or no), back propagation target (yes or no), direct error (yes or no), forwardpass propagation error (yes or no), forwardpass target (yes or no), direct target (yes or no), local loss (yes or no), and global signal (yes or no).

Direct error and direct target means that a model for the networks 210-280 uses the error or dataset target directly at layer hi. Direct target can be replaced in LL and SG with direct error or temporary use of backpropagation, for example. A forward signal propagation signal means the model uses the learning signal starting at the input layer instead of starting at the output layer. A global signal means the learning signal is propagated through the network instead of sent directly to or formed at each hidden layer.

With continued reference to the networks 210-280 of FIGS. 2A-2H, the light grey arrows indicate the feed forward path and the dark grey arrows indicate error gradient or learning signal paths. If the dark grey arrow pass through a layer, the weights are not trained by the gradient or learning signal. Dotted lines indicate the weights are not trained. Double lines are forwarding the context c or state hᵢ, without modification. Double arrows indicate going through one or more layers. Wᵢ and Sᵢ are trained weights and Bᵢ are fixed random weights. The loss function is L and takes the output of the previous layer and possibly some target y when unspecified. According to one or more embodiments described herein, forward signal propagation (see, e.g., FIG. 2H) can be applied for any loss function, such as cross entropy, mean squared error, triplet margin loss, and/or the like, including combinations and/or multiples thereof. The target generator layer S₁ generates the initial training target tᵢ from a learning signal, which is some privileged information or context c, usually the label in supervised learning. The gradient is σ and the synthetic gradient is \hat{σ}. Auxiliary networks are represented by the double arrows going into aᵢ and σᵢ.

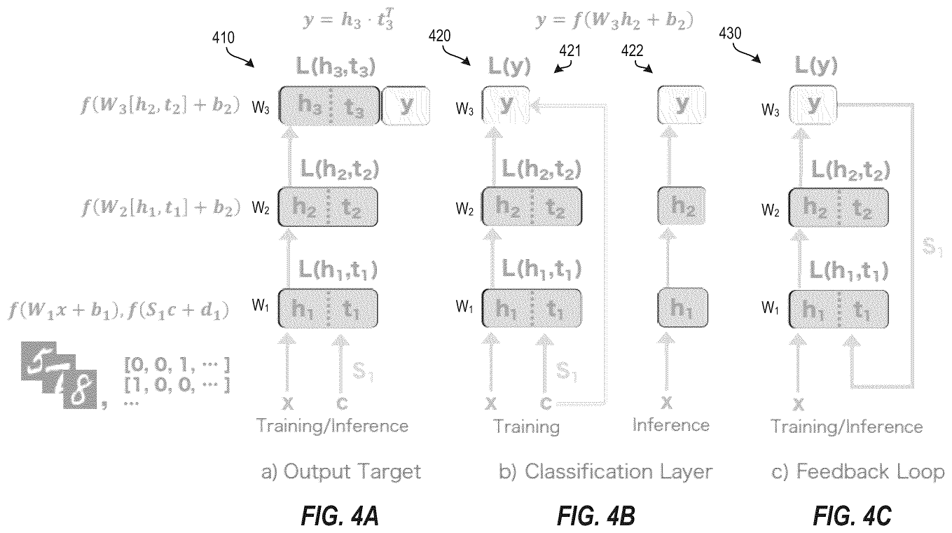

Forward signal propagation learning is now described in more detail with reference to FIG. 2H and FIGS. 4A-4C. The premise of forward signal propagation learning is to reuse the forward path to map an initial learning signal into targets at each layer for updating parameters. According to one or more embodiments described herein, forward signal propagation learning can apply for any parameter update technique, such as local updates, Hebbian learning, and/or the like, including combinations and/or multiples thereof. According to one or more embodiments described herein, forward signal propagation learning can run online and/or offline for inference, training, and/or updating. According to one or more embodiments described herein, forward signal propagation can be implemented for training before deployment of an adaptive system, taking the system offline after deployment for additional training, or training during deployment. According to one or more embodiments described herein, forward signal propagation learning can be implemented alone and/or with other techniques for training machine learning models such as neural networks, such as local learning, synthetic gradients, backpropagation, equilibrium propagation, feedback alignment, shallow learning, direct feedback alignment, target propagation, and/or the like, including combinations and/or multiples thereof. The network is shown in FIG. 4A. The initial learning signal is some context, usually the label in supervised learning, that is processed by a target generator to output an initial target which is then fed forward through the network on the same path as the input. The target generator is loosely a transpose of the classification layer, but has an output size to match the first hidden layer, whereas the classification layer has an input size to match the last hidden layer. Each layer processes its input and initial target to create an output and output-target. The layer compares its output with its output-target to update its parameters. In this way, the layer locally computes its update from a global learning signal. The layer then sends its output and output-target to the next layer which will compute its own update. This processes continues until the last layer has computed its update and produces the network's output (prediction). From this procedure collectively, the network learns to process the input to produce an output, and at the same time, learns to make an initial learning signal into a useful training target at each hidden layer and output layer.

Training the network 280 for forward signal propagation learning is now described with reference to FIGS. 2H and 4A-4C. The forward pass starts with the input x, a learning signal c, and the target generator. The target generator is conditioned on some context c, usually the classes k in supervised learning. For example, let (x, y*) be a mini-batch of inputs and labels where the labels are out of m classes. Assume the network has two hidden layers, as shown in FIGS. 4A-4C, where Wᵢ and bᵢ are weight and bias for layer i. Let S₁ and d₁ be the weight and bias for the target generator. The activation function f( ) is a non-linearity. A one-hot vector of each class cₘ is created and feed it to the target generator.

h₁,t₁=f(W₁x+b₁),f(S₁cₘ+d₁) (1)

[h₂,t₂]=f(W[h₁,t₁]+b₂) (2)

[h₃,t₃]=f(W₃[h₂,t₂]+b₂) (3)

The outputted t₁ is a target for the output of the first hidden layer h₁. This target is used to compute the loss L₁(h₁, t₁) for training the first hidden layer and the target generator. Then, the target and the output are fed to the next hidden layer. The forward pass continues this way until the output layer. The output layer and each hidden layer have their own losses:

J=L(h₁,t₁)+L(h₂,t₂)+L(h₃,t₃) (4)

where J is the total loss for the network. For hidden layers, the loss L can be a supervised loss, such as L_{pred} (Eq. 9) which is described in more detail herein. The loss L can also be a Hebbian update rule, such as (Eq. 14) which is also described in more detail herein. For the output layer, the loss L is a supervised loss, such as L_{pred} (Eq. 9).

After the first hidden layer, the target does not use a separate hidden layer. Rather, the target and the output use the same forward path. The network itself, which is the forward path (see, e.g., FIGS. 2H and 4A-4C), takes on the role of the feedback connectivity in producing a learning signal for each layer. This makes forward signal propagation learning compatible with models of learning where backward connectivity is limited, such as in the brain and learning in hardware (e.g., neuromorphic chips).

Once the network 280 is trained, the network 280 can be used to make predictions. Prediction is now described in more detail. For example, for forward signal propagation learning, the prediction y is formed by comparing the last layer's output (e.g., h₃ of FIG. 2H) with its target t₃ (see FIG. 2H). Forward signal propagation learning can be performed with or without a classification layer, and the use of a classification layer may not effect performance. Both versions (with and without a classification layer) are now described. According to one or more embodiments described herein, forward signal propagation can be performed for any suitable task, such as generative, regression, classification, and/or the like, including combinations and/or multiples thereof.

The network's prediction y at the output layer is formed by comparing the output h₃ and outputted target t₃:

y=y₃=O(h₃,t₃) (5)

where O is a comparison function. Two possible comparison functions are the dot product (Eq. 6) and L2 distance (Eq. 7), although other comparison function may also be used:

O_{dot}(hᵢ,tᵢ)=hᵢ·t^{T} (6)

Oₗ₂(hᵢ,tᵢ)=Σₖ∥tᵢ[i,1,k]−hᵢ[1,j,k]∥₂² (7)

The O_{dot} approach is relatively less complex, but both versions provide similar performance using the losses described herein. Each hidden layer can also output a prediction known as early exits:

y=yᵢ=O(hᵢ,tᵢ) (8)

In forward signal propagation learning, the learning signal c (e.g., labels in supervised learning) is at the input of the network. A classification layer projects the learning signal c into the last layer of the network as shown in FIG. 4B but simplifies predictions during inference. In this case, the target t₃ is no longer used during inference to form y, so neither is the context generator.

In forward signal propagation learning, losses compare neurons with themselves over different inputs and with each other. The L_{pred} is the basic loss used. The prediction loss is a cross entropy loss using a local prediction (Eq. 8). The local prediction is from a dot product between the layer's local targets tᵢ and the layer's output hᵢ. The layer's output is from the network's input x. The local targets are from the target generator. The target generator is conditioned on the class labels cₘ (e.g., the learning signal) to compute one initial target per label. The local targets for each layer are computed from these initial targets through the forward pass. Samples with the same class label have the same local target. Given a vector of classes k=(k₁, . . . , kₘ), a hidden layer's local targets tᵢ=(t₁, . . . , tₘ), and a size n mini-batch of outputs hᵢ=h¹, . . . , hⁿ) of the same hidden layer:

L_{pred}(hᵢ,tᵢ)=CE(y′^{←},−O_{dot}(hᵢ,tᵢ)) (9)

Where hᵢ and tᵢ have the same size output dimension. The cross entropy loss (CE) uses yᵢ*, which is a reconstruction of the labels y* at each layer i from the positional encoding of the inputs x and context c, starting from the activations h₁ and targets t₁ formed at the first hidden layer. In particular, a new batch [h₁, t₁] is formed by interleaving h₁ and t₁ such that each sample's activations in h₁ is concatenated after its corresponding target t₁. Then, at each layer i, a label for each sample hᵢⱼ is assigned depending on which target tᵢₖ the sample came after, where 0≤k<j. Many different encodings are available in embodiments. An alternative is to use the approach further described herein which merges the context c, and therefore generated targets t₁, with the inputs x to form a single combined input xₜ, an input-target, and then either compares them with each other or uses an update rule over multiple iterations. The second option is natural for continuous networks where multiple iterations (e.g., time steps) can support robust update rules.

Target generators for forward signal propagation are now described. The target generator takes in some context to condition learning on and then produces the initial learning signal fed forward through the network. There are many possible formulations of the target generator, and three examples are described to address different learning scenarios: target-only, target-input, and target-loop.

The target-only approach is described herein with reference to Eq. 1 and conditions on the class label. This version of the target generator can interfere with batch normalization statistics as h₁ and t₁ do not necessarily have similar enough distribution. Batch normalization statics may be disabled or be put in inference mode when processing the targets, therefore only collecting statistics on the input.

The target-input approach conditions on the class label and input. A one-hot vector of the labels yₘ* is fed through the target generator to produce a scale and shift for the input. The scaled and shifted output is takes as the target for the first hidden layer.

t₁=h₁f(S₁cₘ+d₁)+f(S₂cₘ+d₂) (10)

Here, the target t₁ is now more closely tied to the distribution of the input. This formulation of the target works better with batch normalization than target-only. Even though this version has similar performance to target-only (Eq. 1), it increases memory usage as each input will have its own version of the targets.

The target-loop approach incorporates a form of feedback. The immediate choice is to condition on the activations of the predictions y₃ and labels yₘ*

t₁=f(S₁y₃+S₁yₘ*+d₁) (11)

or using the output of the last layer and the error to correct it

$${t}_{1} = f ( {S}_{1} ( {h}_{3} - η {e}_{3} ) + {d}_{1} \qquad ( 12 )$$

$${t}_{1} {=}^{Δ} f ( {S}_{1} ( {h}_{3} - η \frac{dL}{{dH}_{3}} ) + {d}_{1}$$

where η controls how much error to integrate. The target-loop generator is shown in the examples of FIGS. 4A-4C and is further described herein with reference to continuous networks.

According to one or more embodiments described herein, forward signal propagation is a form of sparse learning. The target generator can be reformulated to produce a sparse target, which is a sparse learning signal. The targets tᵢ can be made as sparse as possible such that at minimum, they can still be taken with each layer's weights Wᵢ, via a convolution or dot-product, and then fed-forward through the network (e.g., the network 280). To make the target sparse, the output size of Sᵢ in the target generator is reduced.

For a convolutional layers, the output size of Sᵢ is made to be the same size as the weights. For example, let there be an input of 32×28×28 and a convolutional hidden layer of 32×16×3×3, where 32 is the in-channels, 28×28 is the width and height of the input, 16 is the out-channels, and 3×3 is the kernel. The dense target's shape is 32×28×28. In contrast, the sparse target's shape is reduced to 10×32×3×3. As a result, even though convolutional layers have weight sharing, there is no weight sharing when convolving with a sparse target.

For fully connected layers, the output size of Sᵢ is made to be smaller than input size of the weights. For example, let there be an input of 1024 and a fully connected hidden layer of 1024×512 features. The dense target's shape would be 1024. In contrast, the sparse target's shape is <1024. Then, the target can be resized to match the layer input size of 1024 by filling it with zeros. With the sparse target, the layer is no longer fully connected.

FIGS. 4A-4C are now described in more detail. Particularly, FIGS. 4A-4C depict networks 410, 420, 430, which are examples of networks that support forward signal propagation learning according to one or more embodiments described herein.

In FIG. 4A (as described with reference to FIG. 2H), for forward signal propagation learning, the prediction y is formed by taking t₃ and h₃. As shown in FIG. 4A, the network 410 includes three layers W₁, W₂, and W₃. The network 410 receives at the first layer W₁ two values: an input “x” and a label “c” associated with the input x. The label c acts as context to the input x. As an example, if the input x is an image of an animal, the label c can indicate what type (class) of animal (e.g., “dog”). These values x and c are used to calculate a loss of the first layer W₁ as L(h₁, t₁). That is, the loss at the first layer W₁ is calculated using the input x and the label c, but not a feedback signal as in conventional back propagation learning. The loss is similarly calculated at the second layer W₂ using the output from the first layer W₁. This is repeated for each layer of the network 410, including the third layer W₃, where the loss is calculated using the output from the second layer W₂. In the example of FIG. 4A, training and inference can be performed using the same network structure. In accordance with the example of FIG. 4A, forward signal propagation learning does not need a classification layer. However, forward signal propagation learning can implement a classification layer as shown in FIG. 4B.

Turning now to FIG. 4B, the network 420 includes a training path 421 and an inference path 422. In this example, a classification layer may be used without effecting performance. In this case, the last hidden layer's outputs are sent to the classification layer. The classification layer has a benefit for inference. During inference, the target t₃ is no longer needed to make predictions, so the context c and target generator are not used.

Turning now to FIG. 4C, the network 430 includes a feedback loop. In this example, the network 430 can be used for training and inference. As an example, the network 430 can be used to perform forward signal propagation learning for a continuous rate model, as described herein. The classification layer feeds back into the input layer creating a feedback loop, so y is the context c: y=c. This feedback loop provides for the target of hidden layers earlier in the neural network to incorporate information from hidden layers later in the neural network without incurring the overhead of reciprocal feedback to every neuron. Continuous networks have multiple iterations, for which the architecture of the network 430 is particularly useful.

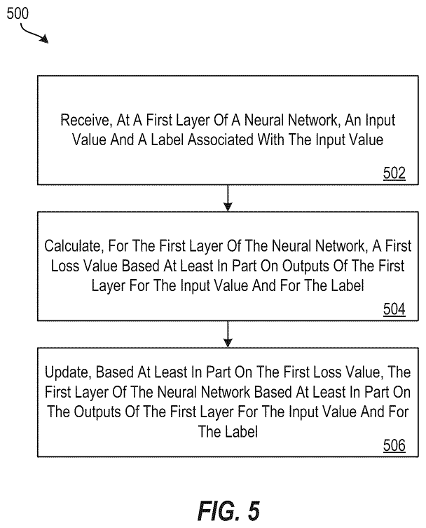

FIG. 5 depicts a flow diagram of a method 500 for forward signal propagation learning according to one or more embodiments described herein. In particular, the method 500 provides for training a neural network (e.g., one or more of the networks 410, 420, 430) using forward signal propagation learning.

At block 502, the method 500 including receiving, at a first layer of a neural network (e.g., the layer W₁ of one or more of the networks 410, 420, 430), an input value (e.g., input x) and a label (e.g., label c) associated with the input value. At block 504, the method 500 includes calculating, for the first layer of the neural network, a first loss value based at least in part on outputs of the first layer (e.g., h₁, t₁ as shown in FIGS. 4A-4C) for the input value and for the label. As an example, the loss is the difference between the values h₁, t₁. At block 506, the method 500 includes updating, based at least in part on the first loss value, the first layer of the neural network based at least in part on the outputs of the first layer for the input value and for the label. This provides for updating a layer of the neural network directly without any additional networks/paths, such as in backpropagation.

According to one or more embodiments described herein, the method 500 can further include receiving, at a second layer of the neural network (e.g., the layer W₂), the outputs of the first layer for the input value and for the label (e.g., h₁, t₁). The method 500 can further include calculating, for the second layer of the neural network, a second loss value based at least in part on outputs of the second layer (e.g., h₂, t₂). The method 500 can further include updating, based at least in part on the second loss value, the second layer of the neural network based at least in part on the outputs of the second layer.

According to one or more embodiments described herein, the neural network includes a classification layer (see, e.g., FIG. 4B). In such an example, an output of a last layer of the neural network is sent to the classification layer.

According to one or more embodiments described herein, the neural network includes a feedback loop (see, e.g., FIG. 4C). According to one or more embodiments, the feedback loop inputs an output of a last layer of the neural network (e.g., W₃ of the network 430) into the first layer of the neural network (e.g., W₁ of the network 430) as the label (S₁) associated with the input value (x). According to one or more embodiments described herein, alternatives to using the “label” is to use the outputs of the last layer or other (e.g., classification, regression, and/or the like, including combinations and/or multiples thereof) layer instead of the label or to create a loop from the last layer or the other layer. Context given as input to the network can be any information that helps the network model the input data for the given task. Additional examples include using the hidden layers instead of a last layer or other layer, samples from other datasets, privileged information about the data, learned encodings, and/or the like, including combinations and/or multiples thereof.

According to one or more embodiments described herein, the method 500 includes, subsequent to training the neural network, performing inference using the neural network.

According to one or more embodiments described herein, the neural network is a sparse neural network.

Additional processes also may be included, and it should be understood that the process depicted in FIG. 5 represents an illustration, and that other processes may be added or existing processes may be removed, modified, or rearranged without departing from the scope of the present disclosure.

Several experiments are now described that were performed to show the benefits of forward signal propagation learning according to one or more embodiments described herein.

Forward signal propagation learning as described herein is now compared to other techniques for training neural networks, such as backpropagation, local learning, feedback alignment, and/or the like (e.g., the models shown in FIGS. 2A-2G). Feedback alignment (FA) uses fixed random weights to transport error gradient information back to hidden layers, instead of using symmetric weights. Local learning can be compared using two model versions. The first uses backpropagation at the layer level (LL-BP), and the second uses FA in the auxiliary networks to have a backpropagation free model (LL-FA). This second model performs better than using FA or DFA alone. FSP can be compared LL with predsim losses on the VGG8b architecture. Several networks were trained on the CIFAR-10, CIFAR-100, and SVHN datasets using a VGG architecture. The experiments were run using the Pytorch Framework. The training was done on a single GeForce GTX 1080. For each layer to have a separate loss, the computational graph was detached before each hidden layer to prevent the gradient from propagating backward past the current layer. The target generator is conditioned on the classes, producing a single target for each class.

Comparison of forward signal propagation learning to backpropagation, LL-BP, and LL-FA is now further described. A batch size of 128 was used. The training time was 100 epochs for SVHN, and 400 epochs for CIFAR-10 and CIFAR-100. ADAM was used for optimization, although any suitable optimization approach can be used, such as ADAM, stochastic gradient descent (SGD), RMSprop optimizer, and/or the like, including combinations and/or multiples thereof. The learning rate was set to 5e−4. The learning rate was decayed by a factor of 0.25 at 50%, 75%, 89%, and 94% of the total epochs. The leaky ReLU activation with a negative slope of 0.01 was used. Batch normalization was applied before each activation function and dropout after. The dropout rate was 0.1 for the datasets. The standard data augmentation included random cropping for the datasets and horizontal flipping for CIFAR-10 and CIFAR-100. The results over a single trial for VGG models.

The CIFAR-10 dataset includes 50000 32×32 RGB images of vehicles and animals with 10 classes. The CIFAR-100 dataset includes 50000 32×32 RGB images of vehicles and animals with 100 classes. The SVHN dataset includes 32×32 images of house numbers. The training of 73257 images and the additional training of 531131 images were used.

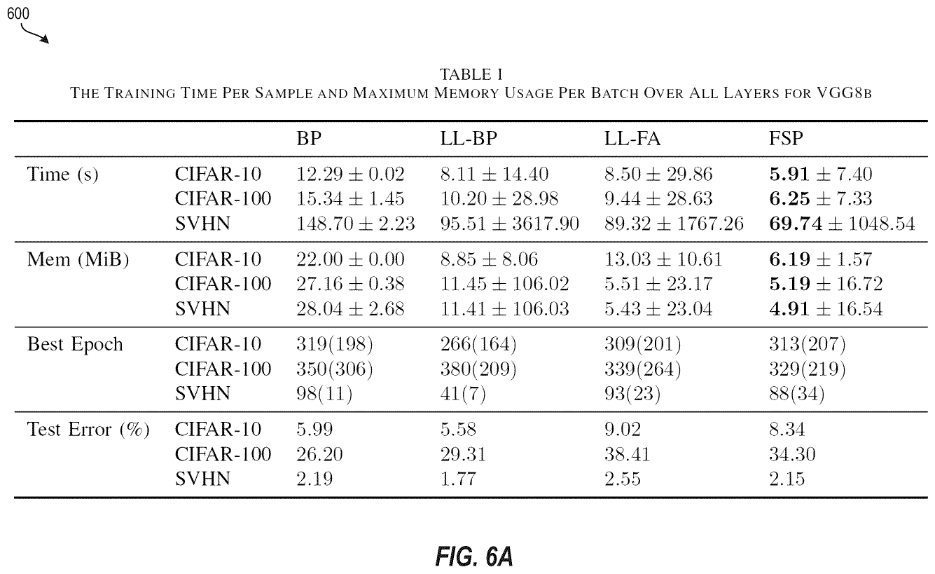

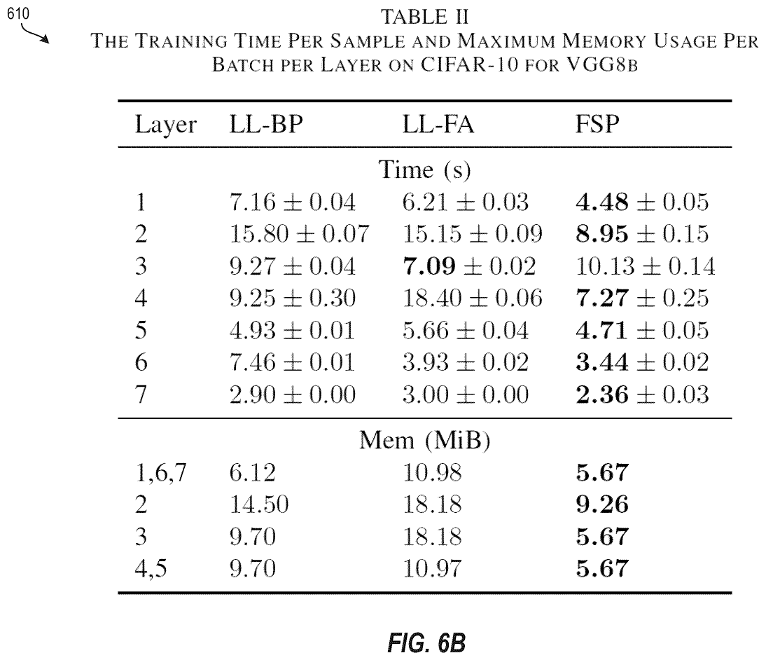

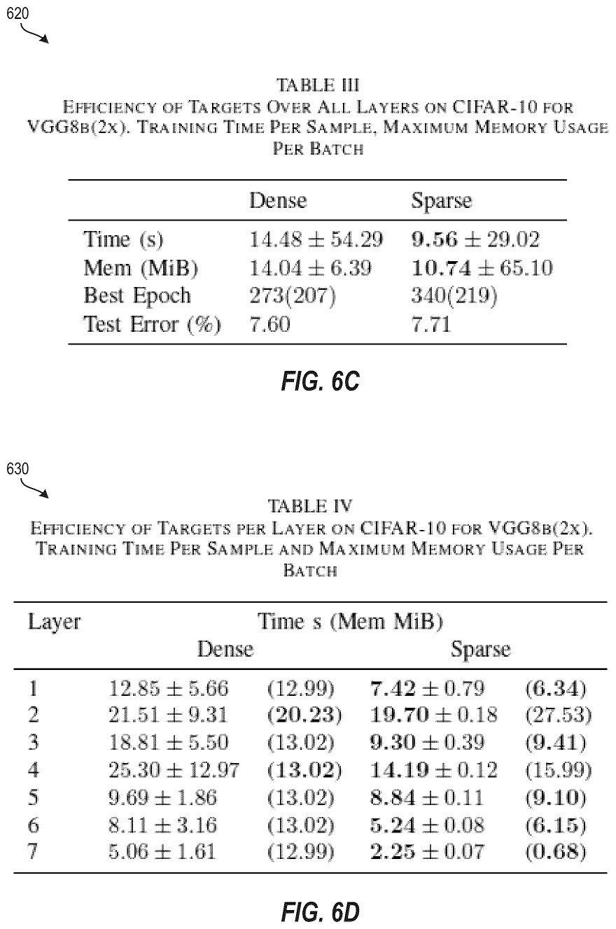

For efficiency, training time and maximum memory usage on CIFAR-10 for BP, LL-BP, LL-FA, and FSP was measured. The version of FSP used is 2b with the Lpred loss. The results are summarized in the table 600 shown in FIG. 6A. Particularly, FIG. 6A depicts a table 600 that includes training time per sample and maximum memory usage per batch per layer over layers for VGG8B according to one or more embodiments described herein. LL and FSP training time are measure per layer as they are forwardpass unlocked and layers can be updated in parallel. However, BP is not forwardpass unlocked, so layers are updated sequentially and is measured at the network level. Measurements are across seven layers, which is the source of the high variance for LL and FSP, and over four hundred epochs of training. To ensure training times are comparable, the epochs at which FSP, LL, and BP converge toward their lowest test error are compared. The first epochs that have performance within 0.5% of the best reported performance were also included. The learning algorithms converge within significance of their best performance around the same epoch. Given efficiency per iteration, FSP is faster than the other learning algorithms and has lower memory usage, as shown in the table 600.

The largest bottleneck for speed of LL and FSP is successive calls to the loss function in each layer. Backpropagation only needs to call the loss function once for the whole network; it optimizes the forward and backward computations for the layers and the batch. FSP and LL would benefit from using a larger batch size than backpropagation. The batch size could be increased in proportion to the number of layers in the network. This is only pragmatic in cases where memory can be sacrificed for more speed (e.g., not edge devices). Per layer measurements are also provided as shown in the table 610 of FIG. 6B. Particularly, FIG. 6B depicts a table 610 that includes training time per sample and maximum memory usage per batch per layer per layer on CIFAR-10 for VGG8B according to one or more embodiments described herein. At the layer level, FSP remains faster and more memory efficient than LL and backpropagation. It can be noted that LL and FSP tend to be slower and faster in different layers even though both are using the same architecture. For memory, FSP uses less memory than LL and BP regardless of the layer. However, there is a general trend for LL and FSP: the layers closer to the input have more parameters, so are slower and take up more memory then layers closer to the output.

According to one or more embodiments described herein, forward signal propagation learning can be used to train a neural network with a sparse learning signal. For example, the VGG8b(2×) architecture can be implemented to leave room for possible improvement when using a sparse target. As an example, the network 420 for forward signal propagation learning with the Lpred loss is used along with the CIFAR10 dataset with the same configuration as described herein. The network's training speed increased and memory usage decreased as shown in tables 620, 630 of FIGS. 6C, 6D respectively with negligible change in accuracy. Particularly, FIG. 6C depicts a table 620 of efficiency of targets over layers on CIFAR-10 for VGG8b(2×), training time per sample, maximum memory usage per batch, according to one or more embodiments described herein. FIG. 6D depicts a table 630 of efficiency of targets per layer on CIFAR-10 for VGG8b(2×), training time per sample and maximum memory usage per batch, according to one or more embodiments described herein.

According to one or more embodiments described herein, forward signal propagation learning can be used to train a neural model in the continuous setting, such as using a Hebbian update mechanism, in addition to the discrete setting. Biological neural networks work in continuous time and have no indication of different dynamics in prediction and learning. In the model presented in this embodiment, the target generator is conditioned on the activations of the output layer to produce a feedback loop as shown in FIG. 4C. According to an embodiment, the feedback loop is active during training and during inference. With this feedback loop, it can be shown that forward signal propagation learning provides useful learning signals by bringing forward and feedback loop weights into alignment. The performance of this model on the MNIST and Fashion-MNIST datasets is also described.

The learning framework, equilibrium propagation (EP), is one way to introduce physical time in deep learning and have the same dynamics in inference and learning, avoiding the need for different hardware for each. In addition, forward signal propagation learning provides for training in hardware, such as neuromorphic chips, which have resource and design constraints that limit backward connectivity. According to one or more embodiments described herein, deep recurrent networks can be trained with a neuron model based on the continuous Hopfield model as follows:

$$\frac{{ds}_{j}}{dt} = \frac{d ρ ( {s}_{j} )}{{ds}_{j}} ( {\sum }_{i \to j} {w}_{ij} ρ ( {s}_{i} ) + {\sum }_{i ∈ O \to j ∈ I} {w}_{ij} ρ ( {s}_{i} ) + {b}_{j} ) - \frac{{s}_{j}}{{r}_{i}} - β {\sum }_{j ∈ O} ( {s}_{j} - {d}_{j} ) \qquad ( 13 )$$

where sⱼ is the state of neuron j, ρ(sⱼ) is a non-linear monotone increasing function of it's firing rate, bⱼ is the bias, β limits magnitude and direction of the feedback, O is the subset of output neurons, I is the subset of input receiving neurons, and dⱼ is the target for output neuron j. The input receiving neurons, sⱼ∈I, are the neurons with forward connections from the input layer. The networks are entirely feedforward except for the final feedback loop from the output neurons sᵢ∈O to the input receiving neurons sⱼ∈I. The weights and biases are trained. The weights in the feedback loop connections may be fixed or trained. The output neurons receive the L₂ error as an additional input which nudges the firing rate towards the target firing rate dⱼ. The target firing rate dⱼ is the one-hot vector of the target value; tasks in this section are classification tasks.

The EP learning algorithm can be broken into the free phase, the clamped phase, and the update rule. In the free phase, the input neurons are fixed to a given value and the network is relaxed to an energy minimum to produce a prediction. In the clamped phase, the input neurons remain fixed and the rate of output neurons sⱼ∈O are perturbed toward the target value dⱼ, given the prediction sⱼ, which propagates to connected hidden layers. The update rule is a simple contrastive Hebbian (CHL) plasticity mechanism that subtracts s⁰ᵢ s⁰ⱼ at the energy minimum (fixed point) in the free phase from s^{β}ᵢ s^{β}ⱼ after the perturbation of the output, where β>0:

$$Δ {W}_{ij} ∝ ρ ( {s}_{i} ) \frac{d}{d β} ( ρ ( {s}_{j} ) ) \approx \frac{1}{β} ρ ( {s}_{i}^{0} ) ( ρ ( {s}_{j}^{β} ) - ρ ( {s}_{j}^{0} ) ) \qquad ( 14 )$$

The clamping factor β provides for the network to be sensitive to internal perturbations. As β→+∞, the fully clamped state in general CHL algorithms is reached where perturbations from the objective function tend to overrun the dynamics and continue backwards through the network.

According to one or more embodiments described herein, forward signal propagation learning provides useful learning signals. For example, the feedback of a forward signal propagation learning module during training has a feedback loop that drives weight changes. Precise symmetric connectivity was thought to be crucial for effective error delivery. Feedback Alignment, however, showed that approximate symmetry with reciprocal connectivity is sufficient for learning. Direct Feedback Alignment showed that approximate symmetry with direct reciprocal connectivity is sufficient. As described herein, it has been shown that no feedback connectivity is necessary for learning, such as by using forward signal propagation learning. An experiment to show that the same approximate symmetry is found in signal propagation learning can be performed.

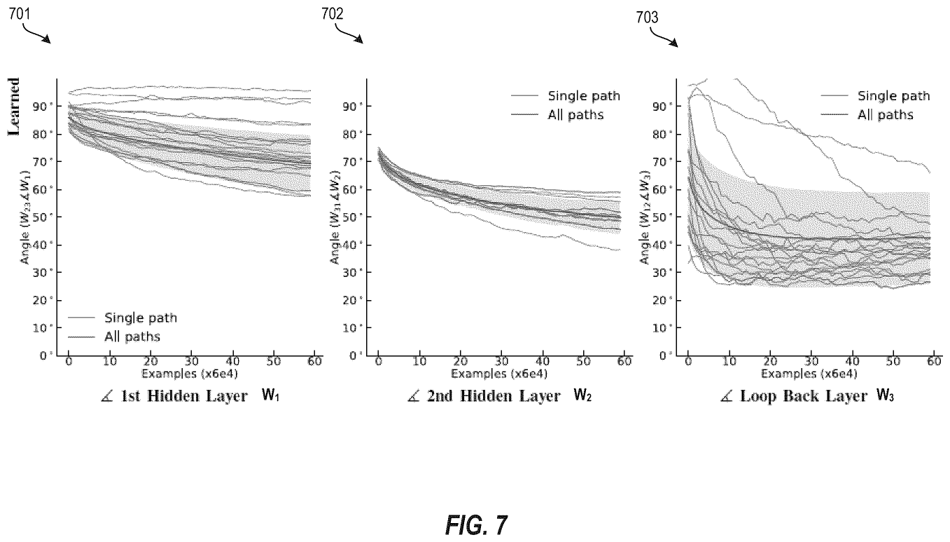

Evidence that signal propagation learning brings weights into alignment within substantially 90° can be provided. This is known as approximate symmetry. In comparison, backpropagation has complete alignment between weights, known as symmetric connectivity. According to an embodiment, the signal propagation learning network architecture forms a loop, so the weights serve as both feedback and feedforward weights. For a given weight matrix, the feedback weights are the weights on the path from the downstream error to the presynaptic neuron. In general, this is the other weights in the network loop. The weight matrices in the loop evolve to align with each other as seen in FIG. 7.

In FIG. 7, three graphs 701, 702, 703 are shown for forward signal propagation learning updating weights according to one or more embodiments described herein. Forward signal propagation learning updates bring weights into alignment within substantially 90°, approaching backpropagation symmetric weight alignment. Forward signal propagation learning provide useful targets for learning. The weight alignment for a network with two hidden layers W₁ and W₂ and one loop back layer W₃ is shown (see, e.g., graphs 701-703 respectively). The weight matrices form a loop in the network and come into alignment with each other during training on the Fashion-MNIST dataset. Each weight matrix aligns with the product of the other two weights forming the network loop. W_{xy}∠W_{z} means the angle between weight z and the matrix multiplication of the weights x and y. The loop back layer is trained. However, even a fixed loop back layer reaches a similar angle of alignment. The loop back layer converges before the 1st and 2nd hidden layers can. The 1st hidden layer (graph 701) is the least aligned with the 2nd hidden layer (graph 702) and the loop back layer because it is dominated by the input signal. The alignment angles are taken for every sample and error bars are one standard deviation

More precisely, each weight matrix roughly aligns with the product of the other weights in the network loop. As shown in FIG. 7, the weight alignment for a network with two hidden layers W₁ and W₂ and one loop back layer W₃ is shown according to one or more embodiments described herein.

Information about W₃ and W₁ flows into W₂ as roughly W₃W₁, which nudges W₂ into alignment with the rest of the weights in the loop. From equation 14, W₂∝ρ(s̅₂⁰)(ρ(s̅₃^{β})−ρ̆(s̅₃⁰)), where \vec{s}₂←ρ(\vec{s}₁)W₁, which means information about W₁ accumulates in W2. Similarly, W₁∝ρ(s̅₁⁰)(ρ(s̅₂^{β})−ρ(s̅₂⁰)), except since the network architecture is a feedforward loop, \vec{s}₁←ρ(\vec{s}₃)W₃, which means information about W₃ accumulates in W₁. The result is shown in the graph 703 of FIG. 7, where a weight matrix is fixed and the rest of the network's weights come into alignment with the fixed weight. It can be observed that W₃W₁ has the same shape as W^{T}₂ and serves as its “feedback” weight.

According to one or more embodiments described herein, a model trained using forward signal propagation learning as comparable performance to EP. One possible example is described. A two and another three layer architecture of 1500 neurons per layer were trained. The two layer architecture was run for sixty epochs and the three layer for one hundred and fifty epochs. The best model during the entire run was kept. On the MNIST dataset, the generalization error is 1.85-1.90% for both the two layer and three layer architectures, an improvement over EP's 2-3%. The best validation error is 1.76-1.80% and the training error decreases to 0.00%. To demonstrate that FSP provides useful learning signals in the previous section, the network was trained on the more difficult Fashion-MNIST dataset. The generalization error is 11.00%. The best validation error is 10.95% and the training error decreases to 2%.

According to one or more embodiments described herein, forward signal propagation learning can be used to train a spiking neural network. Spiking is the form of neuronal communication in biological and hardware neural networks. Spiking neural networks (SNN) are known to be efficient by parallelizing computation and memory, overcoming the memory bottleneck of artificial neural networks (ANN). However, SNNs are difficult to train. A key reason is that spiking equations are non-derivable, non-continuous and spikes do not necessarily represent the internal parameters, such as membrane voltage of the neuron before and after spiking. Spiking also has multiple possible encodings for communication when considering time which are non-trivial, whereas ANNs have a single rate value for communication. One approach to training SNNs is to convert an ANN into a spiking neural network after training. Another approach is to have an SNN in the forward path but have a backpropagation friendly surrogate model in the backward path, usually approximately making the spiking differentiable in the backward path to update the parameters. One or more embodiments described herein provide for training SNNs with forward signal propagation learning. With forward signal propagation learning, the target is forwarded through the network with the input, so learning is done before the non-derivable, non-continuous spiking equation. That is, there is no need to differentiate a non-derivable, non-continuous spiking equation. Also, the SNN has the same dynamics in inference and learning and has no reciprocal feedback connectivity. This makes forward signal propagation learning ideal for on-chip, as well as off-chip training of spiking neural networks. The performance of this model was tested on the Fashion-MNIST dataset.

According to one or more embodiments described herein, a convolutional spiking neural network with integrate-and-fire (IF) nodes was trained. IF nodes are treated as activation functions. The IF neuron can be viewed as an idea integrator where the voltage does not decay. The subthreshold neural dynamics can be express as follows:

vᵢ^{t}=vᵢ^{t-1}+hᵢ^{t} (15)

where v^{t}ᵢ is the voltage at time t for neurons of layer i and h′ᵢ is the layer's activations. The surrogate spiking function for the IF neuron is the arc tangent as follows

$$ℊ ( x ) = \frac{1}{π} arctan ( π x ) + \frac{1}{2} \qquad ( 16 )$$

where the gradient is defined by

$${ℊ}^{′} ( x ) = \frac{1}{1 + {( π x )}^{2}} \qquad ( 17 )$$

The neuron spikes when the subthreshold dynamics reach 0.5 for FSP, and 1.0 for BP and Shallow models. The models are simulated for 4 time-steps, directly using the subthreshold dynamics. The SNN has 4 layers. The first two are convolutional layers, each followed by batch normalization, an IF node, and a 2×2 maxpooling. The last two layers are fully connected, with one being the classification layer. The output of the classification layer is averaged across all four time steps and used as the network output. ADAM was used for optimization. The learning rate was set to 5e−4. Cosine annealing was used as the learning rate schedule with the maximum number of iterations Tmax set to 64. The models are trained on the MNIST and Fashion-MNIST datasets for 64 epochs using a batchsize of 128. An automatic mixed precision was used for 16-bit floating operations, instead of the only the full 32-bit. The reduced precision is better representative of hardware limitations for learning. The classification layer version of the forward signal propagation learning network of FIG. 4B was used.

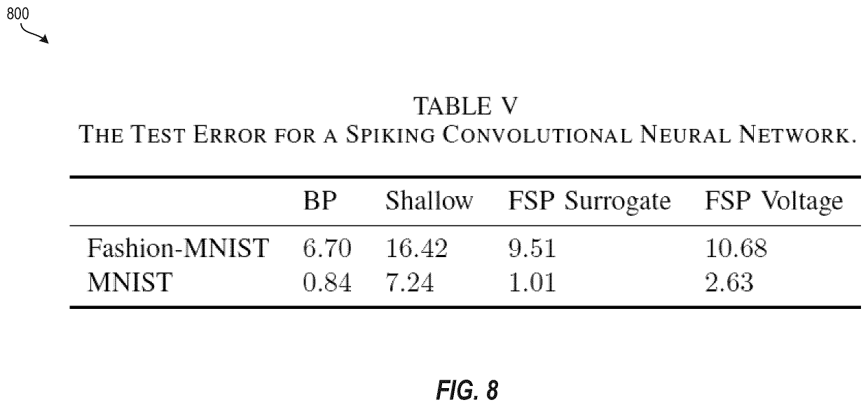

The results of the test for training a SNN is as follows. Four spiking models were compared on the MNIST and Fashion-MNIST datasets as shown in the table 800 of FIG. 8. Particularly, FIG. 8 depicts a table 800 of the test error for a spiking convolutional neural network. The BP model propagates backward through the spiking equations at each layer using a differentiable surrogate. The Shallow model only trains the classification layer. The FSP Surrogate model uses the same differentiable surrogate as BP does, but FSP propagates forward through the network and does not need to go through the spiking equation to deliver a learning signal. That is, the parameter update and surrogate are before or perpendicular to spiking, possibly as separate compartment. Finally, the FSP voltage model uses the neuron's voltage to calculate the loss and update the parameters, no surrogate is used. FSP is able to train the spiking network, but a differentiable nonlinear function estimating the spiking behavior (i.e., surrogate) is necessary to come close to BP performance. Even without a surrogate, the FSP Voltage model is able to train the network significantly better than the Shallow model. Forward signal propagation learning provides a global supervised (unsupervised, reinforcement) learning signal that satisfies requirements for hardware (on-chip) learning.

As described herein, forward signal propagation learning has faster training time and lower memory usage than BP, LL-BP, and LL-FA. The reason forward signal propagation learning is more efficient than BP is clear: forward signal propagation learning is forwardpass unlocked while BP is backwardpass locked. For LL-BP and LL-FA, forward signal propagation learning is more efficient as it has fewer layers for learning (i.e., auxiliary networks). LL-BP has two auxiliary layers for every hidden layer. LL-FA has three auxiliary layers for every hidden layer.

As described herein, sparse targets with a much smaller size than the hidden layer outputs are able to train the hidden layer as well as dense targets with the same size as the hidden layer outputs. A feature of learning in the brain and biological neural networks is sparsity. A small fraction of the neurons weigh in on computations and decision making. Forward signal propagation learning is able to learn just as well with a sparse learning signal as compared to a dense learning signal.

As described herein, forward signal propagation learning can be applied to a time continuous model using a Hebbian plasticity mechanism to update weights, demonstrating forward signal propagation learning has dynamical and structural compatibility with biological and hardware learning. With this continuous model, forward signal propagation learning is able to provide useful learning signals.

As described herein, forward signal propagation learning does not need to go through a non-derivable, non-continuous spiking equation to provide a learning signal to hidden layers. This makes forward signal propagation learning ideal for hardware (on-chip) learning. Furthermore, forward signal propagation learning is able to train an SNN using only the voltage at a reduced 16-bit precision. So, no additional complex circuitry is necessary. This makes on-chip global learning (e.g., supervised or reinforcement) more plausible with forward signal propagation learning, whereas the complex neuron and synaptic models of previous supervised learning algorithms are impractical [8], [46]. This is in addition to forward signal propagation learning not having architectural requirements for learning and having the same type of computation for learning and inference, which on their own address hardware constraints restricting the use of previous supervised learning algorithms.

As described herein, forward signal propagation learning provides for updating neural network parameters via a forward pass. Learning signals can be fed through the forward path to train neurons. Feedback connectivity is not necessary for learning. In biology, this means that neurons who do not have feedback connections can still receive a global learning signal. In hardware, this means that global learning (e.g., supervised or reinforcement) is possible even though there is no backward connectivity. Forward signal propagation learning generates targets from learning signals and then re-uses the forward path to propagate those targets. With this combination, there are no additional structural or computational requirements for learning. Furthermore, the network parameters are updated as soon as they are reached by a forward pass. According to an embodiment, forward signal propagation learning can be used for parallel training of layers or modules.

It is understood that one or more embodiments described herein is capable of being implemented in conjunction with any other type of computing environment now known or later developed. For example, FIG. 9 depicts a block diagram of a processing system 900 for implementing the techniques described herein. In accordance with one or more embodiments described herein, the processing system 900 is an example of a cloud computing node of a cloud computing system/environment. In examples, processing system 900 has one or more central processing units (“processors” or “processing resources” or “processing devices”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display 935 (e.g., a display monitor) is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 to coordinate the functions of the various components shown in processing system 900.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for training a neural network using forward signal propagation learning, the method comprising:
receiving, at a first layer of the neural network, an input value and a label associated with the input value;
calculating, for the first layer of the neural network, a first loss value based at least in part on outputs of the first layer for the input value and for the label; and
updating, based at least in part on the first loss value, the first layer of the neural network based at least in part on the outputs of the first layer for the input value and for the label.

2. The method of claim 1, further comprising:
receiving, at a second layer of the neural network, the outputs of the first layer for the input value and for the label;
calculating, for the second layer of the neural network, a second loss value based at least in part on outputs of the second layer; and
updating, based at least in part on the second loss value, the second layer of the neural network based at least in part on the outputs of the second layer.

3. The method of claim 1, wherein the neural network comprises a classification layer, wherein an output of a last layer of the neural network is sent to the classification layer.

4. The method of claim 1, wherein the neural network comprises a regression layer, wherein an output of a last layer of the neural network is sent to the regression layer.

5. The method of claim 1, wherein the neural network comprises a generative layer, wherein an output of a last layer of the neural network is sent to the generative layer.

6. The method of claim 1, wherein the neural network comprises a discriminative layer, wherein an output of a last layer of the neural network is sent to the discriminative layer.

7. The method of claim 1, wherein the neural network comprises a feedback loop.

8. The method of claim 7, wherein the feedback loop inputs an output of a last layer of the neural network into the first layer of the neural network as the label associated with the input value.

9. The method of claim 1, subsequent to training the neural network, performing inference using the neural network.

10. The method of claim 1, wherein the neural network is a sparse neural network and the label is a sparse learning signal.

11. The method of claim 1, wherein the neural network is implemented on a neuromorphic chip.

12. The method of claim 1, wherein the label comprises information that is used by the neural network to model the input data for a given task.
